(19) United States
(12) Patent Application Publication
(10) Pub. No.: US 2009/0314054 A1
(43) Pub. Date: Dec. 24, 2009

(54) WHEELCHAIR BALANCE TOOL AND METHOD

(75) Inventor: William Mark Richter, Nashville, TN (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: MAX MOBILITY, LLC, Nashville, TN (US)

(21) Appl. No.: 12/145,157

(22) Filed: Jun. 24, 2008

(51) Int. Cl. G01G 23/01

(52) U.S. Cl. 73/1.13

(57) ABSTRACT

A balance tool for evaluating weight distribution of a wheelchair positioned on an elongated platform with a support extending from a lower surface and a linear scale, a measuring bar slideably movable relative to the linear scale for making measurements of horizontal distances between a center of mass and the center of the front wheels and the rear wheels, for determining the relative weight carried by the wheels and for adjusting the position of the wheels to have the rear wheels carry a substantial majority of the weight. A method of adjusting the balance of a wheelchair is disclosed.

### TECHNICAL FIELD

The present invention relates to tools for configuring a wheelchair. More particularly, the present invention relates to a balance for determining weight distribution in order to configure a wheelchair for a user.

### BACKGROUND OF THE INVENTION

Wheelchairs are mobility devices by which a person who is unable to walk can move while engaging in ordinary life activities. Wheelchairs typically have a seat and back attached to a chassis or frame. A pair of drive wheels attach to opposing sides of the frame. A pair of caster wheels mount to opposing forward portions of the frame. Accessory devices including lateral side supports, pads, and cushions, attach to the frame or seating structure for supporting an individual occupying the seat. Anti-tip arms typically extend rearwardly from the frame close to a surface over which the wheelchair moves. The anti-tip arms restrict the wheelchair from tipping over backwards.

The anti-tip arms are particularly useful because the wheelchair typically is configured so that a substantial majority of the weight distribution is carried rearwardly on the wheelchair. This makes the front portion of the wheelchair relatively light and the chair is “tippy”. The anti-tip arms restrict the wheelchair from tipping over backwards. This weight distribution however is beneficial to facilitate the driving operation of the wheelchair by the user. The front end rolls on the surface but is relatively easier to move over surface obstructions such as grass, gravel, curbing, transitions between floor surfaces, rugs and the like. In some instances, the user of the wheelchair preferably elevates the front end so there is less rolling resistance to facilitate movement of the wheelchair.

Wheelchair weight balance distribution can be manually accomplished by repeated configuration and test rolling by the user of the wheelchair. This however is time consuming and may not be entirely satisfactory as the test rolling of a particular configuration may not test the particular situations that the user faces, and subsequent reconfiguration is needed.

Accordingly, there is a need in the art for a tool for evaluation of the weight distribution of wheelchairs. It is to such that the present invention is directed.

### BRIEF SUMMARY OF THE INVENTION

The present invention meets the needs in the art by providing a balance tool for evaluating weight distribution of a wheelchair, comprising a platform having a support that extends from a lower surface thereof and a linear scale attached to the platform and extending longitudinally relative to the platform. A guide slideably attaches to the platform and an indicator extends perpendicularly therefrom, the guide movable relative to the linear scale for aligning the indicator in order to make measurements of horizontal distances between a center of gravity of a wheelchair and occupant positioned on the platform and the center of the front wheels and of the rear wheels of the wheelchair.

In another aspect, the present invention provides a method of balancing weight distribution of a wheelchair, comprising the steps of:

(a) positioning a wheelchair on a platform having a planar surface and opposing upstanding side walls, the platform including a support that extends from a lower surface thereof intermediate opposing longitudinal ends of the platform, the wheelchair moved thereon to align the center of gravity in alignment with the support;

(b) moving an indicator longitudinally relative to the support to align selectively with a center of a front wheel and with a center of a rear wheel;

(c) measuring the horizontal distance between the support and the selected front wheel and rear wheel;

(d) determining the distribution of weight on the front and rear wheels;

(e) adjusting the position of rear wheel relative to the front wheel to position a substantial majority of the weight on the rear wheels.

Objects, advantages, and features of the present invention will become apparent upon a reading of the following detail description in conjunction with the drawings and the appended claims.

### BRIEF DESCRIPTION OF THE DRAWINGS

FIG. 1 is a perspective view of the balance tool in accordance with the present invention.

FIG. 2 is a detailed side view of a slidable guide and indicator used with the balance tool shown in FIG. 1.

FIG. 3 illustrates in perspective view the balance tool shown in FIG. 1 being used for determining the weight distribution for a wheelchair.

FIG. 4 is a detailed partially cut-away side view of an alternate embodiment of the guide and indicator used with the balance tool shown in FIG. 1.

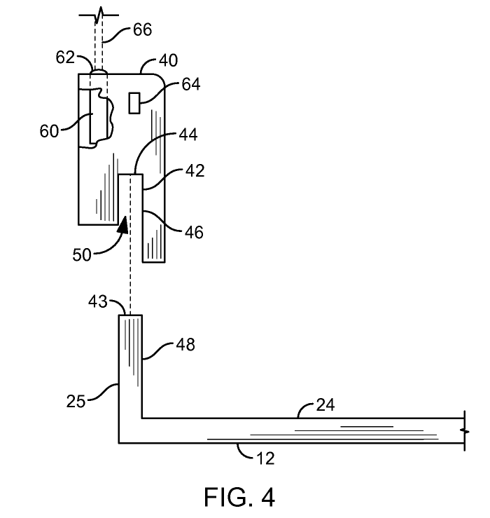

### DETAILED DESCRIPTION

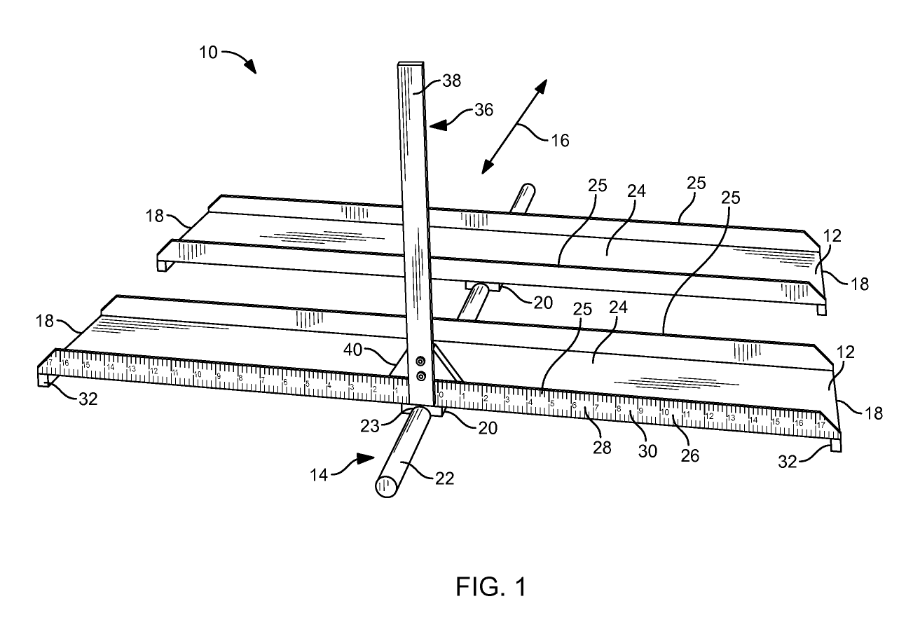

With reference to the drawings, in which like identifiers have like reference numerals, FIG. 1 illustrates in perspective view a balancing tool 10 for determining weight distribution during configuration of a wheelchair for a user. The balance tool 10 includes a pair of spaced-apart platforms 12. The platforms 12 receive the spaced-apart wheels of a wheelchair to be evaluated, as discussed below. An alternate embodiment (not illustrated) uses a single platform sized for receiving a wheelchair. A fulcrum 14 extends from a lower surface of the platform 12. The fulcrum 14 is aligned with a transverse axis medial opposing longitudinally spaced edges 18 of the platform 12.

In the illustrated embodiment, the fulcrum 14 comprises an elongated support 20 mounted to a lower surface of the platform and an elongated tube 22. The support 20 defines a channel 23. The channel 23 aligns with the transverse axis 16 of the platform 12. The channels 23 of the spaced-apart platforms 12 receive the elongated tube 22. The tube 22 in the illustrated embodiment is a one-inch diameter tube.

The platforms 12 are U-shaped in cross-sectional view with a planar surface 24 and a pair of opposing upstanding sidewalls 25. A scale 26 attaches to an outside face of one of the opposing sidewalls 24. The scale 26 includes a graduation of intervals with a plurality of uniformly spaced demarcations 28 and associated numerical indicia 30. In the illustrated embodiment, the scale 26 centers at a zero (“0”) value along the transverse axis 16. The indicia 30 increment sequentially unitarily in opposing directions from the scale mid-point to the edges 18. For example, in one embodiment, the scale 26 centers at zero “0” and includes ruler graduations of inches, half inches, quarter inches, and eighth inches, for measuring purposes, with the numerical indicia associated with the inch graduation marks.

In the illustrated embodiment, the platforms 12 include feet 32 extending from a lower surface at the edges 18 of the platform 12. The feet 32 extend to a distal edge. The distance is in a range of between about ¼ to ½ inch. The tube 22 however extends further from the platform 12. This leaves a gap between a distal edge of the feet 32 and a surface on which the fulcrum 14 sits. The platforms 12 accordingly can pivot on the fulcrum 14 so that one edge 18 of the platform is elevated and the opposing edge is lowered.

A guide or slider 36 slidingly attaches to the platform 12. In the illustrated embodiment, the slider 36 slidably attaches to the one of the side walls 25 having the scale 26. In an alternate embodiment (not illustrated) the slider seats on the support surface of the platform aligned with the scale 26. The slider 36 includes an indicator for aligning with selected portions of the wheelchair such as a central hub of the wheel for taking horizontal measurements as discussed below. In the illustrated embodiment, the indicator is an elongated arm 38 and the body of the slider defines a support 40 attached to a side of the arm near a first end. The arm 38 extends upwardly from the platform 12.

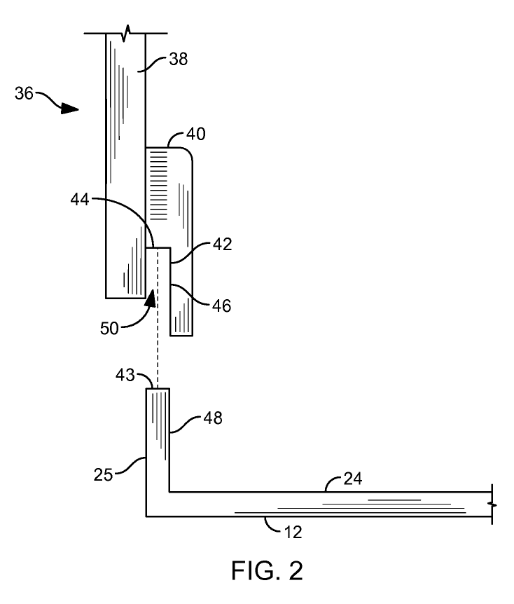

As illustrated in exploded view in FIG. 2, the support 40 defines a notch 42 with a first sliding face 44 that moves on a distal edge 43 of the side wall 25 and a second sliding face 46 that moves on an inner side face 48 of the side wall 25. Fasteners such as screws or rivets secure the arm 38 to the support 40. The support 40 and the arm 38 cooperatively define a gap 50 for receiving the side wall 25.

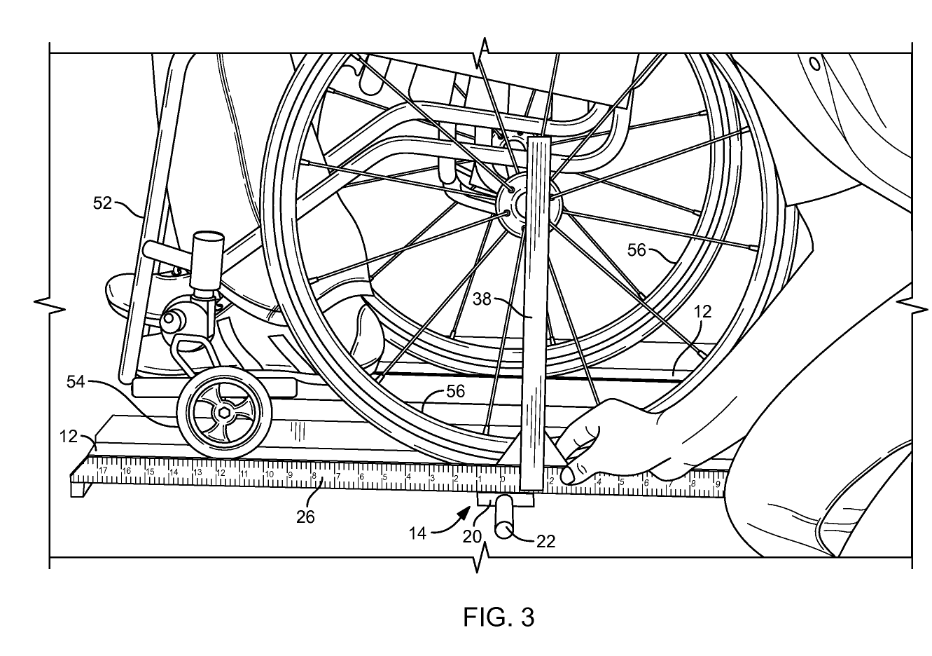

FIG. 3 illustrates the balancing tool 10 in use during weight distribution determination for configuration of a wheelchair 52. The balancing tool 10 readily assembles by placing the tube 22 on a surface such as a floor. The platforms are positioned in spaced-apart relation on the tube 22 with the channels 23 of the supports 22 receiving a portion of the tube 22. The platforms 12 are tilted by pivoting on the tube 22 so one end 18 is lowered to the surface on which the tube 22 sits. The wheelchair 52 is occupied by the user (partially illustrated), who rolls the wheelchair onto the platforms 12.

The wheelchair is then positioned so that the center of gravity of the user and the wheelchair is directly above the fulcrum 14. The center of gravity of the wheelchair and occupant is the point through which the resultant of gravitational forces on the user and the wheelchair passes and is coincident with the center of mass in a uniform gravitational field. The positioning of the wheelchair is accomplished by moving the wheelchair longitudinally relative to the platform 12 between the opposing ends 18 and observing that the platforms 20 are relatively balanced in side view (the platform 12 is approximately level).

A physical therapist or other individual configuring the wheelchairs (partially illustrated) moves the slider 26 longitudinally to align an edge of the arm 38 with a center or hub of the front wheel 54. The edge of the arm 38 indicates on the scale 26 the distance from the center of gravity of the occupied wheelchair 30. The horizontal distance from the fulcrum 14 to the center of hub of the rear drive wheels 56 is also measured.

The distances are used to calculate the percent of weight on the front and rear wheels. This determination gives a measure of the stability of the wheelchair occupied by the user. Preferably, the wheelchair is configured with a substantial majority of the weight towards the rear. Typically, 70 to 95% of the weight is carried on the rear wheels.

FIG. 3 illustrates in partially cut-away side view an alternate embodiment of the balancing tool 10. A light-emitting device 60 installs in the support 40. The device 60 emits a narrow focused beam 66, such as a laser-emitting device and eliminates the portion of the vertical arm 38 that extends from the support in a direction away from the platform 12. Laser devices are conventional and operate on batteries. The support 40 in this embodiment includes a window 62 through which the beam 66 emits and a battery compartment selectively openable (not illustrated) for replacing batteries from time-to-time. An on-off switch 64 communicates electrically between the batteries and the device 60 to control selectively the emission of the laser light.

The support 40 with the lower portion of the member 38 slidably engages the scale 26. The light emitting device 60 emits the narrow beam 66 through the window 62 away from the platform 12 upwardly towards the wheelchair. The light is projected onto the wheelchair, and the support 40 moved slidingly to align with the center of the wheel hub. The scale 26 is then read relative to the slide 40 for determining the horizontal distance measurements. The use of the laser light device reduces potential errors in measurement that may arise from looking at the vertical guide or member 38 at an angle.

In response to the determination of weight distribution, the wheelchair stability can be adjusted. This is accomplished by moving the axle of the drive wheels longitudinally relative to the frame of the wheelchair. A properly balanced wheelchair facilitates the user of the wheelchair moving the wheelchair, for example, across grass, roads, curbs, carpeting, and the like. A properly balanced wheelchair also facilitates moving the wheelchair downhill. Often wheelchair users will cause the front end of the wheelchair to elevate. This is accomplished by the user sitting back in the wheelchair and forcing the front of the wheelchair to elevate. This provides more comfortable seating as the user is not leaning forward. The anti-tip members extending from the rear of the wheelchair prevent the wheelchair from tipping over.

The wheelchair balance tool and method disclosed herein can be made and executed without undue experimentation in light of the present disclosure. While the apparatus and methods of this invention have been described in terms of illustrative embodiments, it will be apparent to those of skill in the art that variations may be applied to the apparatus and in the method steps or in the sequence of steps thereof described herein without departing from the concept, spirit and scope of the invention. All such similar substitutes and modifications apparent to those skilled in the art are deemed to be within the spirit, scope and concept of the invention as defined by the appended claims.

What is claimed is:

1. A balance tool for evaluating weight distribution of a wheelchair, comprising:
a platform having a support that extends from a lower surface thereof;
a linear scale attached to the platform and extending longitudinally relative to the platform;
a guide slideably attached to the platform and movable relative to the linear scale for making measurements of horizontal distances between a center of gravity of a wheelchair and occupant positioned on the platform and the front and rear wheels of the wheelchair; and
an indicator extending from the guide for aligning with a center hub of the front and rear wheels wheelchair during measuring.

2. The balance tool as recited in claim 1, wherein the support comprises:
a first elongated member attached transverse to a longitudinal axis of the platform on a lower surface thereof and defining a channel; and
a second elongated member received in the channel and extending laterally from opposing sides of the platform.

3. The balance tool as recited in claim 1, wherein the platform comprises two platform members that each include a support transverse to a longitudinal axis thereof, the support defining a channel therein; and further comprising an elongated member received in the channels of the platform members disposed in space-apart relation.

4. The balance tool as recited in claim 3, wherein each platform member is U-shape in cross-section with a planar portion for receiving wheels of a wheelchair and two opposing upstanding side walls.

5. The balance tool as recited in claim 4, wherein the linear scale attaches to one of the side walls.

6. The balance tool as recited in claim 5, wherein the guide is configured for receiving the one of the side walls and for sliding longitudinally relative to the linear scale.

7. The balance tool as recited in claim 6, wherein the indicator comprises an elongated arm attached to the guide to cooperatively define a gap therebetween for receiving the side wall therein, the arm extending therefrom for aligning with the hubs for taking measurements.

8. The balance tool as recited in claim 7, wherein the guide includes a notch that defines a first sliding face that moves on a distal edge of the side wall and a second sliding face that moves on a side face of the side wall.

9. The balance tool as recited in claim 6, wherein the indicator comprises a light emitting device attached to the guide for emitting a light that aligns with the hubs for taking measurements.

10. The balance tool as recited in claim 8, wherein the guide includes a notch that defines a first sliding face that moves on a distal edge of the side wall and a second sliding face that moves on a side face of the side wall.

11. The balance tool as recited in claim 1, wherein the liner scale defines a zero position medial opposing ends of the platform and includes a plurality of uniformly spaced demarcations, whereby the distance can be readily determined.

12. The balance tool as recited in claim 11, wherein each of the demarcations includes a spaced-apart numerical sequential indicia indicating the distance relative to the zero position.

13. The balance tool as recited in claim 1, wherein opposing longitudinal edges of the platform include feet extending from the lower surface.

14. The balance tool as recited in claim 13, wherein the feet extend from the platform a first distance and the support extends a second distance from the platform, the second distance greater than the first distance.

15. A balance tool for evaluating weight distribution of a wheelchair, comprising:
a pair of elongated platforms having a planar surface and opposing upstanding side walls, each platform including a support that extends from a lower surface thereof and defines a channel therein;
a linear scale attached to at least one side wall of one of the platforms, the linear scale extending longitudinally relative to the platform;
a guide slideably attached to the platform and movable relative to the linear scale for making measurements of horizontal distances between a center of mass of a wheelchair and occupant positioned on the platform and a selected portion of the wheelchair;
the guide including indicator means for aligning with the selected portion of the wheelchair for measurements; and
an elongated member received in the channels of the platform members disposed in space-apart relation for receiving on the planar surface thereof respective wheels of a wheelchair.

16. The balance tool as recited in claim 15, wherein the guide is configured for receiving the one of the side walls and for sliding longitudinally relative to the linear scale.

17. The balance tool as recited in claim 16, wherein the indicator comprises an elongated arm attached to the guide to cooperatively define a gap therebetween for receiving the side wall therein, the arm extending therefrom for aligning with the wheelchair for taking measurements.

18. The balance tool as recited in claim 17, wherein the guide includes a notch that defines a first sliding face that moves on a distal edge of the side wall and a second sliding face that moves on a side face of the side wall.

19. The balance tool as recited in claim 16, wherein the indicator comprises a light emitting device attached to the guide for emitting a light that aligns with the hubs for taking measurements.

20. The balance tool as recited in claim 19, wherein the guide includes a notch that defines a first sliding face that moves on a distal edge of the side wall and a second sliding face that moves on a side face of the side wall.

21. The balance tool as recited in claim 13, wherein the linear scale defines a zero position medial opposing ends of the platform and includes a plurality of uniformly spaced demarcations and an associated numerical indicia indicating the distance relative to the zero position, whereby the distance can be readily determined.

22. A method of adjusting the balance of a wheelchair comprising the steps of:
(a) positioning a wheelchair on a platform having a planar surface and opposing upstanding side walls, the platform including a support that extends from a lower surface thereof intermediate opposing longitudinal ends of the platform, the wheelchair moved thereon to align the center of gravity in alignment with the support;
(b) moving an indicator longitudinally relative to the support to align selectively with a center of a front wheel and with a center of a rear wheel;
(c) measuring the horizontal distance between the support and the selected front wheel and rear wheel;
(d) determining the distribution of weight on the front and rear wheels;
(e) adjusting the position of rear wheel relative to the front wheel to position a substantial majority of the weight on the rear wheels.
